(19) United States
(12) Patent Application Publication
(10) Pub. No.: US 2005/0217514 A1
(43) Pub. Date: Oct. 6, 2005

(54) Hand-operated press for trash containers

(76) Inventor: Hubert Rudolf Griengl, Klagenfurt (AT)

Correspondence Address: YOUNG & THOMPSON, 745 SOUTH 23RD STREET, 2ND FLOOR, ARLINGTON, VA, 22202, US

(21) Appl. No.: 11/082,933

(22) Filed: Mar. 18, 2005

(30) Foreign Application Priority Data
Mar. 18, 2004 (AT) A 480/2004

(51) Int. Cl. B30B 1/00

(52) U.S. Cl. 100/226; 100/233

(57) ABSTRACT

To compact or compress trash, especially residual trash, in trash containers (1) of households and businesses, a cheap device which is easy to handle is made available which has a lever (4) with a handle (7) and a connecting device (9) which is attached to the lever (4) for connecting the lever (4) to the trash container (1). Furthermore a plunger (5) with which the trash in the trash container (1) can be compressed is connected to the lever (4).

The invention relates to a hand-operated device for compaction of garbage in garbage containers.

In private households and especially also in businesses the problem often arises that space in the available garbage or trash containers is often not sufficient. In many cases this problem can be alleviated by compacting the garbage, especially the residual garbage, in the trash containers. Therefore the object of the invention is to make available a cheap device which is easy to handle and with which the garbage in trash containers can be compacted.

This object is achieved with a hand-operated device with the features of claim 1.

The device as claimed in the invention has a very simple structure, since it has essentially only one lever which can be hung on the trash container, and a plunger which is attached to the lever and which compacts the trash in the trash barrel by pressing the lever down.

Preferably the plunger has a rod and a pressing element. The pressing element is that part which comes to rest on the trash, the pressing element being pressed onto the trash and into the trash container by the rod which can have a variable length if necessary.

Preferred embodiments of the invention are the subject matter of the other dependent claims.

Preferred embodiments of the invention are described below with reference to the drawings.

FIG. 1 shows the device as claimed in the invention when trash is being compacted in a trash container;

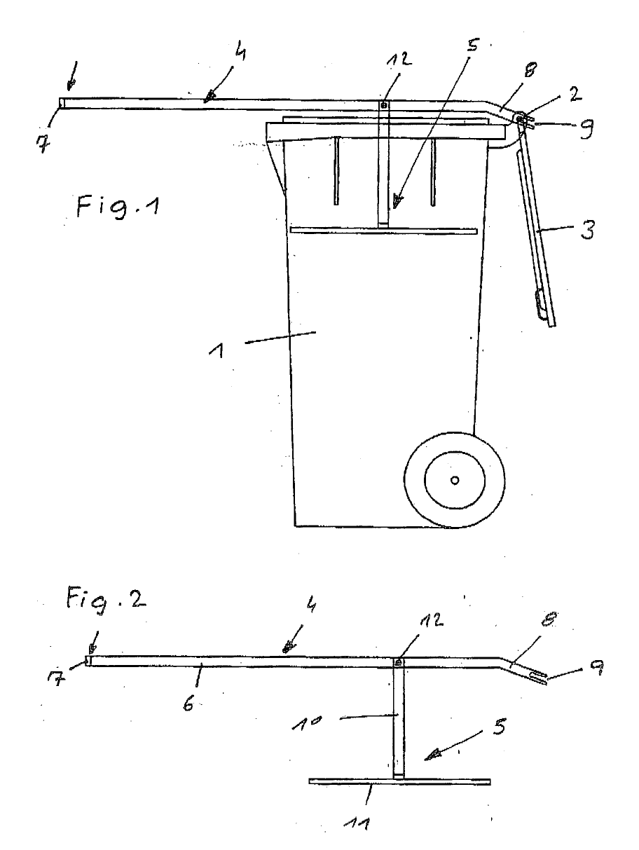

FIG. 2 shows the device according to FIG. 1 without the trash container;

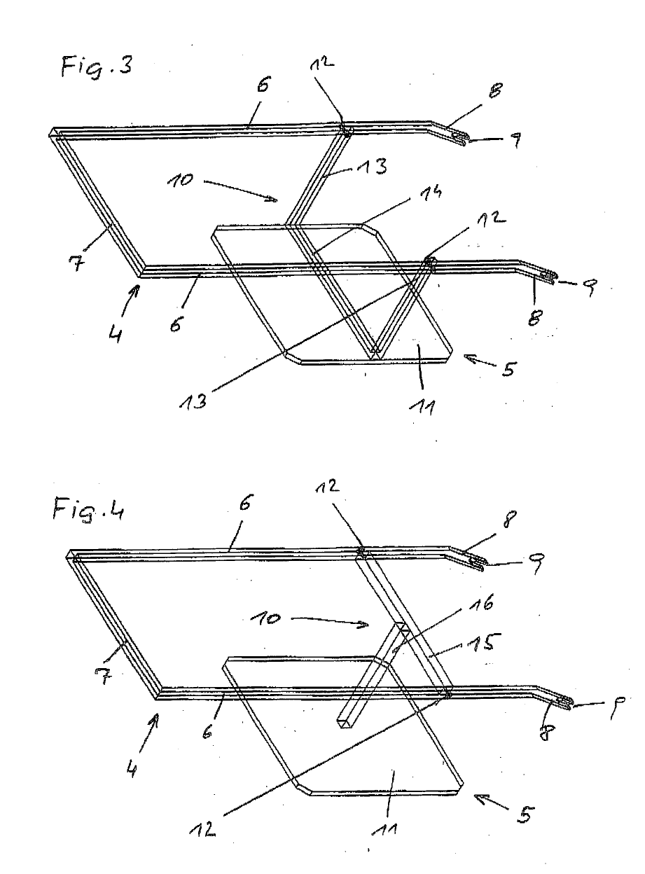

FIG. 3 shows a first embodiment of the device as claimed in the invention in an oblique view;

FIG. 4 shows a second embodiment of the device as claimed in the invention in an oblique view;

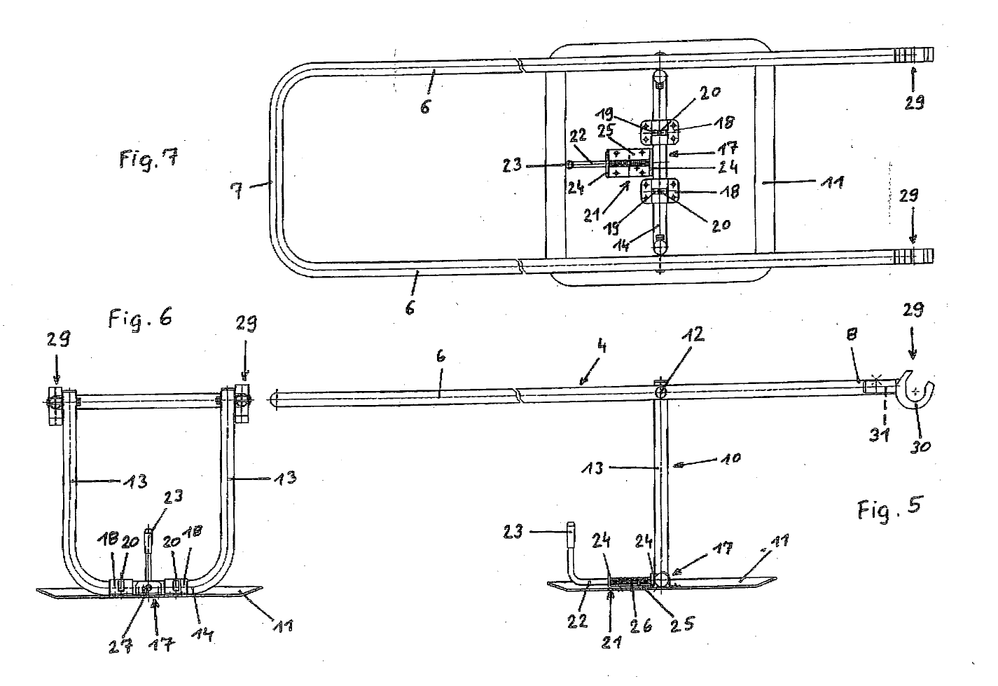

FIG. 5 shows a third embodiment of the device as claimed in the invention in a side view;

FIG. 6 shows a view of the device from FIG. 5 from the right;

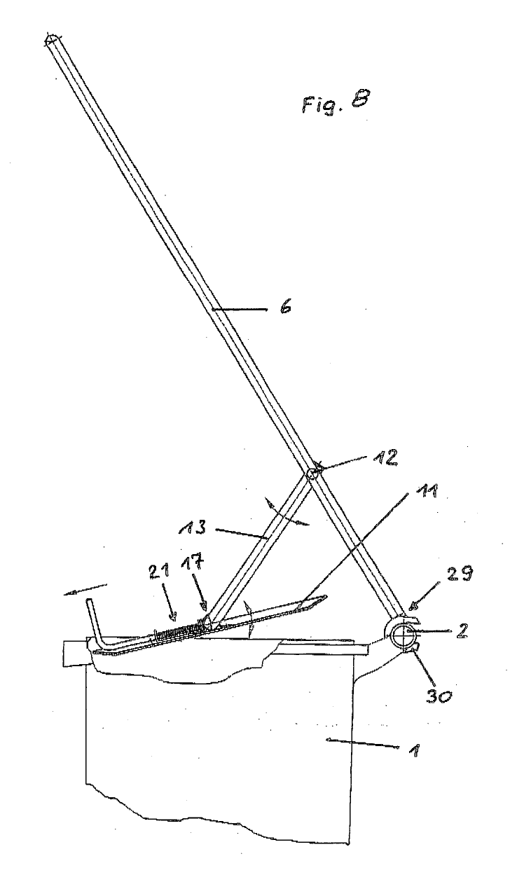

FIG. 7 shows a top view of the device from FIG. 5; and

FIG. 8 shows a view of the device from FIG. 5 in the position of use.

FIG. 1 shows a trash container or trash barrel 1 as is often used in households and commercial businesses. A cover 3 with which the trash barrel 1 can be closed is supported on these trash barrels via a hinge 2.

To compact the contents of the trash barrel 1 there is a device as claimed in the invention which has essentially a lever 4 and a plunger 5. The lever 4 in the embodiments shown has a U shape with two legs 6 and one crosspiece 7. The crosspiece 7 is used as a handle. On the free ends 8 opposite the crosspiece 7, the legs 6 in the embodiment of FIGS. 1 to 4 have slots 9 which are used as a connecting device to the trash barrel 1, by the legs 6 with the slots 9 being slipped onto hinge pins or articulated shafts of the hinge 2 on the trash barrel 1.

On their inner end the slots 9 can have widened areas or depressions into which the hinge pins or articulated shafts of the hinge 2 can be inserted in order to prevent the legs 6 from slipping too easily off the hinge.

The plunger 5 in this embodiment consists of a rod 10 and has a pressing element 1 in the form of a plate 11. Instead of a solid pressing plate 11, of course also H-shaped, lattice-like or rake-like constructions can also be used.

In the embodiments shown in FIGS. 1 to 4 the rod 10 is made with a fixed length and is rigidly connected to the pressing plate 11. But it is also possible to make the rod 10 of variable length, for example, telescopic, in order to be able to compact the trash or other garbage into deeper areas of the trash barrel 1.

The rod 10 is connected to the legs 6 of the lever 4 via joints 12 since possible rotary motion between the rod 10 and the lever 4 when the lever is being pushed down and the trash compacted is helpful. The joints 12 are therefore also advantageous because the device as claimed in the invention can thus be more easily folded together in this way when not in use. According to the embodiment from FIGS. 5 to 8, there could also be a joint between the rod 10 and the pressing plate 11 since then the device as claimed in the invention can be further folded.

FIGS. 3 and 4 show two embodiments of rods 10. On the one hand, in FIG. 3 it is a U-shaped rod consisting of two legs 13 and one crosspiece 14 which is connected to the pressing plate 11. In the case of FIG. 4 the rod 10 has essentially a T shape, the transverse beam 15 being connected via the joints 12 to the legs 6, conversely the vertical beam 16 is connected to the pressing plate 11.

Instead of the slots 9 on the free ends 8 of the legs 6 of the lever 4, also other types of connecting devices could be provided there, for example, hooks or the like, as is shown in FIGS. 5 to 8. Nor is it critical that the lever 4 in the area of the hinge 2 be connected to the trash barrel 1. What is important is simply that the lever 4 is connected directly or indirectly to the trash barrel 1 or is hooked onto it somewhere so that the plunger 5 can be pressed into the trash barrel 1 by pressing the lever 4 down.

It is also conceivable for the lever or handle 7 not to be permanently connected to the connecting device 9, but for this to take place via a joint or lever system in order to enable increased power transmission from the handle 7 to the plunger 4.

FIGS. 5 to 8 show another embodiment of a device as claimed in the invention in which the pressure plate 11 is connected to the crosspiece 14 of the rod 10 via a joint 17. This joint 17 is formed by two clips 18 which are screwed or welded to the pressing plate 11 and through which the crosspiece 14 is guided. To prevent the plate 11 from slipping along the lengthwise axis of the crosspiece 14, in the clips 18 slots 19 are made, through which screws 20 are screwed into the crosspiece 14 and extend when screwed in through the slots 19 and thus allow the plate 11 to be turned around the crosspiece 14, but prevent lateral displacement of the plate 11 with the clips 18 along the crosspiece 14.

Since the plate 11 can thus be swivelled by roughly 180° relative to the rod 10 and the rod 10 for its part by roughly 180° relative to the lever 4, the device as claimed in the invention when not in use can be folded very flat.

In order to prevent the pressing plate 11 from turning in an undesirable manner relative to the rod 10 when the device is being used, there is a locking device 21 which has a pin 22 with a handle 23 which is bent by 90°. In the legs 24 of a U-shaped plate 25 which is welded or screwed to the pressing plate 11 the pin 22 can be moved along its lengthwise axis 22 so far that it is pushed into the recess 26 in the crosspiece 14 of the rod 10 and can also be pulled out of it again entirely. The pin 22 is pressed by a spring 26 into the locking position against the crosspiece 14. If the pressing plate 11 is in the position shown in FIG. 5, the pin 22 also catches automatically by the force of a spring 26 in the recess or hole 27. By pulling back the pin 22 on the handle 23, the lock can be released and the plate 11 can be swivelled relative to the rod 10 as can be seen for example in FIG. 8. The handle 23 can if necessary also be folded down to further reduce the amount of space required for the device in the folded-together state.

In the embodiment as shown in FIGS. 5 to 8, furthermore a connecting device 29 which has been modified compared to the embodiment in FIGS. 1 to 4 is shown, with which the lever 4 can be hooked on the trash barrel 1. This connecting device 29 consists essentially of a roughly U-shaped hook part 30 which is inserted via a journal 31 into the end of the leg 6 of the lever 4, which leg is made tubular in this case, and attached there, for example, screwed on.

In summary, one embodiment of the invention can be described in that to compact or compress the trash, especially residual trash, in trash containers of households and businesses a cheap device which is easy to handle is made available which has a lever 4 with a handle 7 and a connecting device 9 which is attached to the lever 4 for connecting the lever 4 to the trash container 1. Furthermore, a plunger 5 with which the trash can be compressed in the trash container 1 is connected to the lever 4.

1. Hand-operated device for compaction of garbage in garbage containers (1), such as trash barrels, characterized by a lever (4) with a handle (7), a connecting device (9, 29) which is attached to the lever (4) for connecting the lever (4) to a trash container (1), and a plunger (5) which is connected to the lever (4) and with which the trash is compressed.

2. Device as claimed in claim 1, wherein the plunger (5) has a pressing element (11) and a rod (10) via which the pressing element (11) is connected to the lever (4).

3. Device as claimed in claim 2, wherein the pressing element (11) is a plate.

4. Device as claimed in claim 2, wherein the pressing element is a H-shaped or lattice-shaped component.

5. Device as claimed in claim 1, wherein the rod (10) is connected via a joint (12) to the lever (4).

6. Device as claimed in claim 1, wherein the connecting device has a groove-shaped or hook-shaped recess (9, 30) on the lever (4).

7. Device as claimed in claim 1, wherein the lever (4) has essentially a U shape, the handle being located on the crosspiece (7) and the connecting device (9) being located on the free ends (8) of the legs (6).

8. Device as claimed in claim 2, wherein the rod (10) is made essentially U-shaped, one crosspiece (14) of the rod (10) being connected to the pressing element (11) and the free ends of the legs (13) of the rod (10) opposite the crosspiece (14) being connected to the legs (6) of the lever (4).

9. Device as claimed in claim 1, wherein the plunger (5), especially its rod (10), is of variable length.

10. Device as claimed in claim 2, wherein the rod (10) is connected via a joint (17) to the pressing element (11).

11. Device as claimed in claim 10, wherein the joint (17) can be locked by means of a locking device (21).

12. Device as claimed in claim 11, wherein the locking device (21) has a pin (22) which is movably supported on the pressing element (11) and which can be moved into a recess (27) on the crosspiece (14) of the rod (10).

13. Device as claimed in claim 12, wherein the pin (22) has a bent handle (23) and can optionally be turned.
